(19) United States
(12) Patent Application Publication
(10) Pub. No.: US 2018/0189545 A1
(43) Pub. Date: Jul. 5, 2018

(54) IMAGE BRIGHTNESS NON-UNIFORMITY CORRECTION METHOD AND IMAGE BRIGHTNESS CORRECTION DEVICE THEREFOR

(71) Applicant: EOSMEM Corporation, Zhubei City (TW)

(72) Inventors: Chu-Hsin Chang, Zhubei City (TW); Cheng-En Hsieh, Zhubei City (TW); Wei-Chung Jen, Zhubei City (TW); Jun-Shian Hsiao, Chupei (TW); Ching-Lung Ti, Chupei (TW); Kai-Ting Ho, Chupei (TW); Chun-Fu Lin, Chupei (TW); Hui-Min Tsai, Taipei (TW)

(21) Appl. No.: 15/858,716

(22) Filed: Dec. 29, 2017

Related U.S. Application Data
(60) Provisional application No. 62/440,746, filed on Dec. 30, 2016.

(30) Foreign Application Priority Data
Aug. 30, 2017 (TW) 106129438

(51) Int. Cl. G06K 9/00

(52) U.S. Cl. CPC G06K 9/00067; G09G 2320/0233; G06K 9/00013

(57) ABSTRACT

The present invention provides an image brightness non-uniformity correction method and an image brightness correction device therefor. The image brightness non-uniformity correction method includes the steps of: (A) generating an initial input image having pixels arranged in a matrix, wherein each pixel has a corresponding pixel brightness and the initial input image has non-uniform brightness; (B) performing a pre-processing procedure on the initial input image, to generate a pre-processed image; (C) performing an image gradient correction procedure on the pre-processed image, to eliminate non-uniformity of the brightness of the initial input image; and (D) outputting an output image having an uniformity-processed brightness.

### CROSS REFERENCE

The present invention claims priority to U.S. 62/440,746, filed on Dec. 30, 2016 and claims priority to TW 106129438 filed on Aug. 30, 2017.

### BACKGROUND OF THE INVENTION

### Field of Invention

The present invention relates to an image brightness non-uniformity correction method and an image brightness correction device therefor; particularly, it relates to such an image brightness non-uniformity correction method capable of eliminating non-uniformity of the brightness of an initial input image through an image gradient correction procedure, and it relates to such an image brightness correction device capable of eliminating non-uniformity of the brightness of an initial input image through an image gradient correction procedure performed by a computation unit therein.

### Description of Related Art

Generally, in a conventional optical image identification system (for example but not limited to a fingerprint identification system), there is an unwanted issue of non-uniform brightness in the image (for example but not limited to a fingerprint image) captured by an input device. This is usually due to non-uniformity of the ambient light source, non-uniformity of the angle of the incident light into the input device, and/or non-uniformity of the image sensing device.

More specifically, non-uniform brightness means that the brightness of an object is not exactly represented by the brightness of the captured image. For example, assuming that the brightness of an object is uniform and consistent across an entire frame. However, due to the issue of non-uniformity, in the captured image, there are deviations of the brightness across the entire frame. For example, the brightness of the pixels near an edge of a fingerprint image may be lower than the brightness of the pixels near the center of the fingerprint image, although the original brightness may be the same at the two areas. As a result, the pixels near the edge suffer brightness degradation and are considerably darker than the pixels at the center, which may undesirably affect the identification accuracy of fingerprint. (To make it clear, the term “defective non-uniform brightness” will be used hereinafter to indicate that the non-uniform brightness is a defect, not the non-uniformity the object itself.)

In view of the above, to overcome the drawback in the prior art, the present invention proposes an image brightness non-uniformity correction method capable of eliminating non-uniformity of the brightness of the initial input image through an image gradient correction procedure. Besides, the present invention also proposes an image brightness correction device capable of eliminating non-uniformity of the brightness of the initial input image through an image gradient correction procedure performed by a computation unit therein.

### SUMMARY OF THE INVENTION

From one perspective, the present invention provides an image brightness non-uniformity correction method, comprising the steps of: (A) generating an initial input image, wherein the initial input image includes a plurality of pixels arranged in a matrix, wherein each pixel has a corresponding pixel brightness and the initial input image has defective non-uniform brightness; (B) performing a pre-processing procedure on the initial input image, to generate a pre-processed image; (C) performing an image gradient correction procedure on the pre-processed image, wherein, the image gradient correction procedure is adopted for eliminating non-uniformity of the brightness of the initial input image; and (D) outputting an output image having an uniformity-processed brightness; wherein, the image gradient correction procedure includes the steps of: (C1) based upon the pre-processed image, for each (a present pixel) of the pixels, generating a brightness difference ratio between the pixel brightness of a pixel immediately following the present pixel and the pixel brightness of the present pixel; (C2) generating a pixel brightness correction value for each pixel by subtracting a basis brightness ratio from the brightness difference ratio; and (C3) performing an integration procedure on each pixel brightness correction value for each pixel, to generate a corresponding integrated pixel brightness correction value for each pixel, wherein, for each present pixel, the integrated pixel brightness correction value is equal to the integrated pixel brightness correction value of an immediately preceding pixel multiplied by (1 plus the pixel brightness correction value of the immediately preceding pixel).

In one embodiment, the image brightness non-uniformity correction method further comprises: before the step (C), estimating brightness information for at least a part of the pixels of the pre-processed image, to generate information of the brightness non-uniformity of the pre-processed image.

In one embodiment, the image brightness non-uniformity correction method further comprises: after the step (C) and before the step (D), for a pixel having a sharp gradient, replacing the integrated pixel brightness correction value of the pixel having the sharp gradient with a predetermined brightness, to eliminate a noise which is generated after the image gradient correction procedure has been performed.

In one embodiment, the predetermined brightness is a middle value obtained from the integrated pixel brightness correction values of at least a part of the pixels.

In one embodiment, the pre-processing procedure includes the steps of: (B1) performing a defect removing procedure on the initial input image, to remove a pixel having defective image information; (B2) performing a smoothing procedure on the defect-removed initial input image, to reduce noise interference on the initial input image; and (B3) performing a sharping procedure on the smoothed initial input image, to enhance contrast among the pixel brightness of the pixels near the edge of the initial input image.

From another perspective, the present invention provides an image brightness correction device, comprising: an image input unit, which is configured to operably generate an initial input image, wherein the initial input image includes a plurality of pixels arranged in a matrix, wherein each pixel has a corresponding pixel brightness and the initial input image has defective non-uniform brightness; a pre-processing unit, which is configured to operably perform a pre-processing procedure on the initial input image, to generate a pre-processed image; and a computation unit, which is configured to operably perform an image gradient correction procedure on the pre-processed image, wherein, the image gradient correction procedure is adopted for eliminating non-uniformity of the brightness of the initial input image; and wherein, after performing the image gradient correction procedure, the computation unit outputs an output image having an uniformity-processed brightness.

In one embodiment, the image gradient correction procedure performed by the computation unit includes the steps of: based upon the pre-processed image, for each (a present pixel) of the pixels, generating a brightness difference ratio between the pixel brightness of a pixel immediately following the present pixel and the pixel brightness of the present pixel; generating a pixel brightness correction value for each pixel by subtracting a basis brightness ratio from the brightness difference ratio; and performing an integration procedure on each pixel brightness correction value for each pixel, to generate a corresponding integrated pixel brightness correction value for each pixel, wherein, for each present pixel, the integrated pixel brightness correction value is equal to the integrated pixel brightness correction value of an immediately preceding pixel multiplied by (1 plus the pixel brightness correction value of the immediately preceding pixel).

The objectives, technical details, features, and effects of the present invention will be better understood with regard to the detailed description of the embodiments below, with reference to the attached drawings.

### BRIEF DESCRIPTION OF THE DRAWINGS

FIG. 1A is a flowchart showing an image brightness non-uniformity correction method according to an embodiment of the present invention.

FIG. 1B shows a schematic block diagram of an embodiment of the present invention, illustrating an image brightness correction device adopting an image brightness non-uniformity correction method according to the present invention.

FIG. 1C shows a schematic block diagram of another embodiment of the present invention, illustrating an image brightness correction device adopting an image brightness non-uniformity correction method according to the present invention.

FIG. 1D shows a schematic diagram of an initial input image having pixels arranged in a matrix.

FIG. 2 is a flowchart showing an image brightness non-uniformity correction method according to a more specific embodiment of the present invention.

FIG. 3A illustrates an example of an initial input image having defective image information before a defect removing procedure on the initial input image is performed.

FIG. 3B shows the brightness of the initial input image corresponding to FIG. 3A.

FIG. 4 shows a schematic signal diagram of a predetermined image information middle value used during the defect removing procedure.

FIG. 5A shows a schematic signal diagram of the defect-removed initial input image.

FIG. 5B shows the brightness of the defect-removed initial input image corresponding to FIG. 5A.

FIG. 6A is a schematic diagram for explaining how the present invention performs a surface estimation procedure.

FIG. 6B shows the brightness of the pre-processed image after the surface estimation procedure has been performed on the pre-processed image.

FIG. 6C shows a comparison between the pre-processed image which has been applied with a surface estimation procedure and the pre-processed image which has not been applied with a surface estimation procedure.

FIG. 7 shows that each pixel has a corresponding pixel brightness.

FIG. 8A-8B show the brightness of the pre-processed image after an image gradient correction procedure has been performed on the pre-processed image.

FIG. 9 shows a comparison between the pre-processed image which has been applied with an image gradient correction procedure and the pre-processed image which has not been applied with an image gradient correction procedure.

FIG. 10 shows an example wherein the pixels have a sharp gradient after an image gradient correction procedure has been performed on the pre-processed image.

### DESCRIPTION OF THE PREFERRED EMBODIMENTS

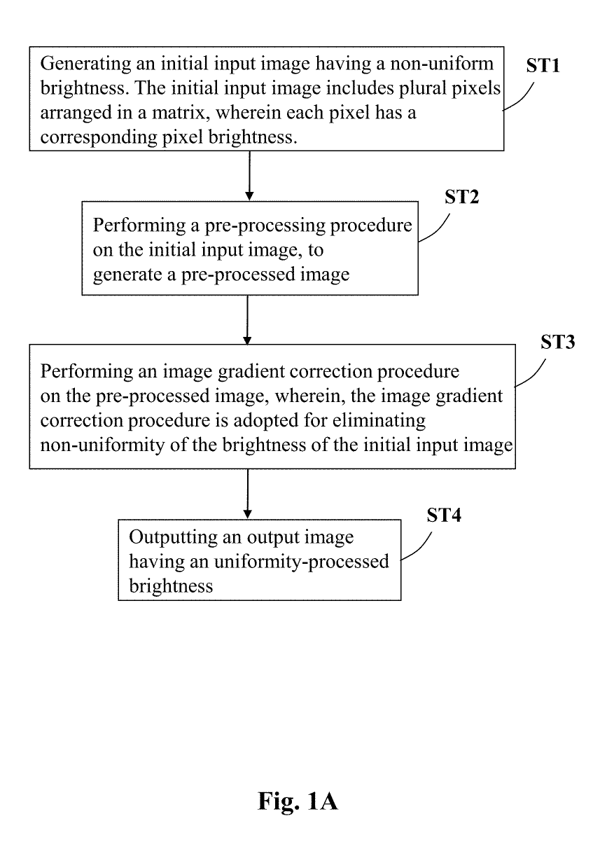

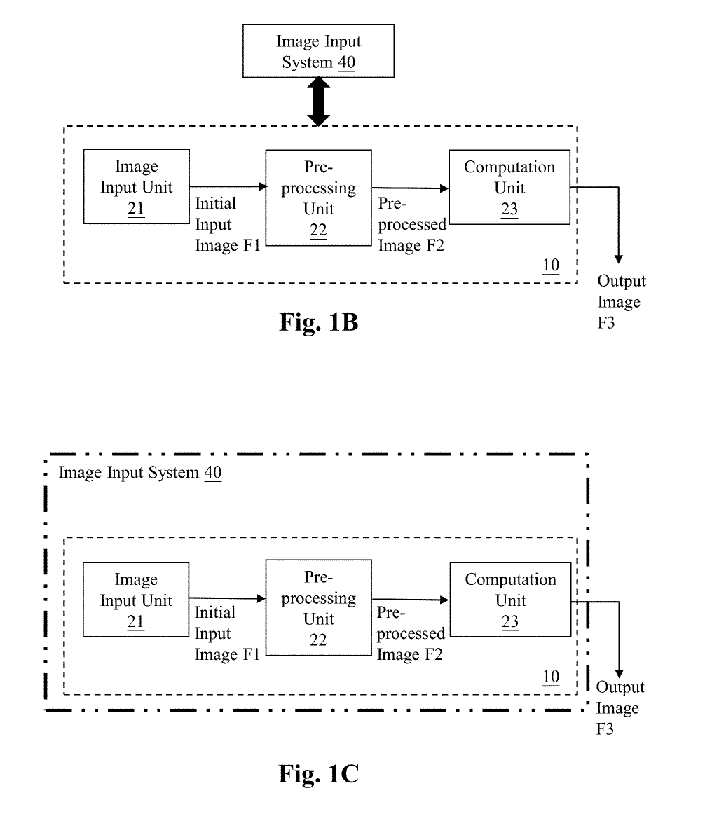

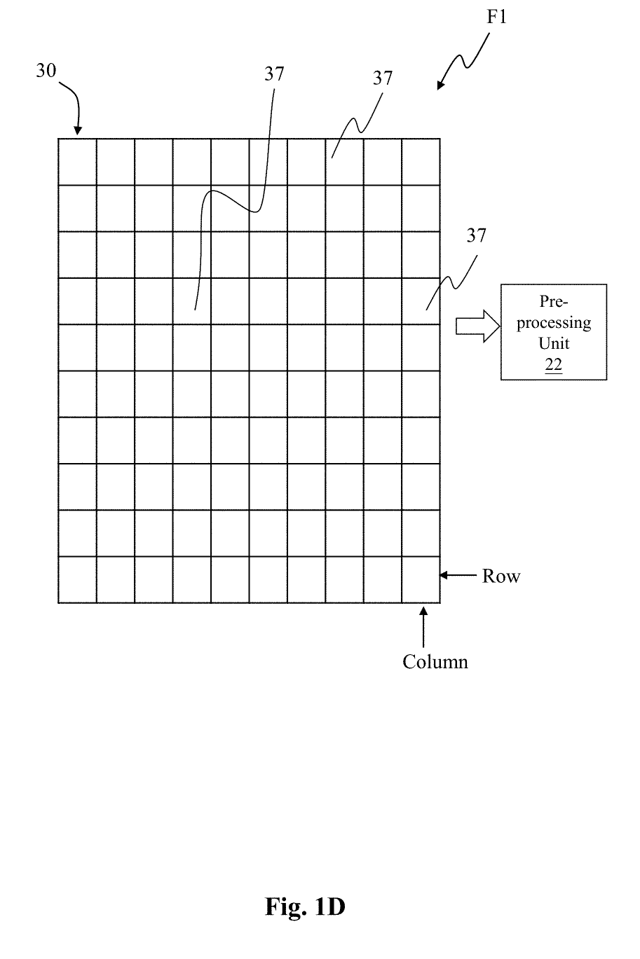

Please refer to FIG. 1A in conjugation with FIGS. 1B-1D. FIG. 1A is a flowchart showing an image brightness non-uniformity correction method according to an embodiment of the present invention. FIG. 1B shows a schematic block diagram of an embodiment of the present invention, illustrating an image brightness correction device which adopts the image brightness non-uniformity correction method according to the present invention. FIG. 1C shows a schematic block diagram of an embodiment of the present invention, illustrating another image brightness correction device which adopts the image brightness non-uniformity correction method according to the present invention. FIG. 1D shows a schematic diagram of an initial input image having pixels arranged in a matrix.

The present invention provides an image brightness non-uniformity correction method, and such image brightness non-uniformity correction method can be applied to an image brightness correction device 10. In one embodiment, the image brightness correction device 10 can be a part of an image input system 40, as shown in FIG. 1C. Or, in another embodiment, the image brightness correction device 10 can be disposed independently, and can be optionally connected to the image input system 40, as shown in FIG. 1B.

In one embodiment, the image brightness correction device 10 includes: an image input unit 21, a pre-processing unit 22 and a computation unit 23.

As shown in FIG. 1B and FIG. 1C, the image input unit 21 is configured to operably generate an initial input image F1 (referring to step ST1 in FIG. 1A). The initial input image F1 can be, for example but not limited to, an image captured by an image capturing device from an original object (e.g. a finger). The initial input image F1 includes plural pixels 37 and the initial input image F1 has non-uniform brightness. In one embodiment, preferably, the pixels 37 can be arranged in a pixel array 30 by columns and rows, as shown in FIG. 1D. In other embodiments, the pixels 37 can be arranged in other forms. Each pixel 37 has a corresponding pixel brightness (referring to step ST1 in FIG. 1A).

That “the initial input image F1 has non-uniform brightness” does not mean the non-uniform brightness of the original object itself, but means that the brightness of the original object is not exactly represented by the brightness of the captured image. For example, referring to FIG. 1D, the three pixels which are labeled 37 should have the same degree of brightness because the positions these three pixels 37 represent on the original object have the same degree of brightness. However, due to the issue of non-uniformity, in the initial input image F1, there is a deviation of the brightness across the entire pixel array 30, causing these three pixels 37 to have different degrees of brightness. For example, the brightness of pixels near the edge of the pixel array 30 may be lower than the brightness of the pixels near the center of the pixel array 30, so that the two pixels 37 near the edge of the pixel array 30 suffer brightness degradation and are considerably darker than the pixel 37 at the center of the pixel array 30.

To overcome the problem of non-uniform brightness of the initial input image F1, the present invention provides an image brightness non-uniformity correction method, and such image brightness non-uniformity correction method can be applied to an image brightness correction device 10.

According to the present invention, the initial input image F1 having a problem of non-uniform brightness is first inputted into the pre-processing unit 22.

The pre-processing unit 22 is configured to operably perform a pre-processing procedure on the initial input image F1 which has non-uniform brightness, to generate a pre-processed image F2 (referring to step ST2 in FIG. 1A)

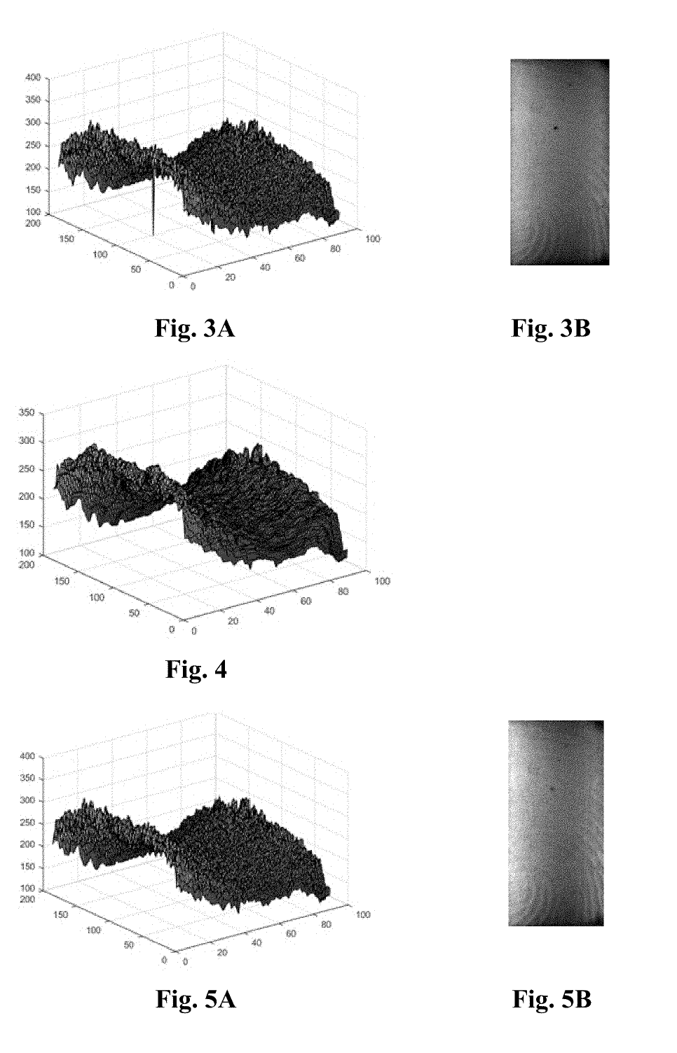

In one embodiment, the pre-processing procedure can include, for example but not limited to: first, performing a defect removing procedure on the initial input image F1 having a non-uniform brightness, to remove one or more pixels having defective image information. In one embodiment, this defect removing procedure can be implemented via, for example but not limited to, a Switch Median Method, to minimize the fuzzy parts in the image information. An example of using this Switch Median Method is shown in FIG. 3A, FIG. 3B, FIG. 4, FIG. 5A and FIG. 5B.

Please refer to FIG. 3A and FIG. 3B. FIG. 3A illustrates that before a defect removing procedure on the initial input image is performed, the initial input image has defective image information. FIG. 3B shows the brightness of the initial input image corresponding to FIG. 3A.

As shown in FIG. 3B, the initial input image F1 has non-uniform brightness. In FIG. 3A, it can be clearly seen that there is a defect in the initial input image F1 having non-uniform brightness.

To remove the defect in FIG. 3A, the Switch Median Method replaces the defect by a predetermined image information middle value. In one embodiment, such predetermined image information middle value is for example but not limited to, as shown in FIG. 4. FIG. 4 shows a schematic signal diagram of a predetermined image information middle value used for the defect removing procedure.

In one embodiment, the Switch Median Method can be represented by an equation as below:

if |Praw(i)−Pmedian(i)|>Pmedian(i)*ratio Praw(i)=Pmedian(i)

where, Praw (i) denotes the original image information of an i^{th} pixel in the pixel array 30 of the initial input image F1; and Pmedian (i) denotes the predetermined image information middle value, such as shown in FIG. 4.

According to the above-mentioned equation, the Switch Median Method is thus: when an absolute value of a difference between “the image information of the i^{th} pixel” and “the predetermined image information middle value” is greater than “the predetermined image information middle value” multiplied by a certain ratio, the image information of the i^{th} pixel is replaced by the “predetermined image information middle value”.

Please refer to FIG. 5A and FIG. 5B. FIG. 5A shows that the defect is removed in the initial input image. FIG. 5B shows the brightness of the defect-removed initial input image corresponding to FIG. 5A.

Please compare FIG. 3B with FIG. 5B. After the initial input image F1 having defective non-uniform brightness shown in FIG. 3B is processed via the Switch Median Method, the defective image information (e.g., a defect pixel) of the initial input image F1 is removed. A comparison between FIG. 3A and FIG. 5A shows that originally there is a defect in the initial input image F1 shown in FIG. 3A, and after processed by the Switch Median Method, such defect has been removed from the initial input image F1.

It is noteworthy that, in the present invention, the defect removing procedure included in the pre-processing procedure is not limited to the Switch Median Method; it is also practicable and within the scope of the present invention to adopt any other method for defect removal. For example, in another embodiment, the defect removing procedure of the present invention can be implemented by means of a Median Method. A Median Method is well known to those skilled in the art, so the details thereof are not redundantly explained here.

Next, in one embodiment, the pre-processing procedure performs a smoothing procedure on the defect-removed initial input image F1, to reduce noise interference on the initial input image F1.

In one embodiment, this smoothing procedure can be implemented via, for example but not limited to, a Gaussian Smoothing Method, to reduce noise interference on the initial input image F1. Gaussian Smoothing Method is well known to those skilled in the art, so the details thereof are not redundantly explained here.

It is noteworthy that, in the present invention, the smoothing procedure included in the pre-processing procedure is not limited to the Gaussian Smoothing Method; it is also practicable and within the scope of the present invention to adopt any other smoothing method.

Next, in one embodiment, a sharping procedure is performed on the smoothed initial input image F1, to enhance the contrast among the brightness of pixels near the edge of the initial input image F1.

In one embodiment, this sharping procedure can be implemented via, for example but not limited to, an Un-Sharp Mask Method, to enhance the contrast among the brightness of pixels near the edge of the initial input image F1. Un-Sharp Mask Method is well known to those skilled in the art, so the details thereof are not redundantly explained here.

It is noteworthy that, in the present invention, the sharping procedure included in the pre-processing procedure is not limited to the Un-Sharp Mask Method; it is also practicable and within the scope of the present invention to adopt any other sharping method.

According to the present invention, after the initial input image F1 having defective non-uniform brightness has been processed via the above-mentioned pre-processing procedure, a pre-processed image F2 is generated. Next, before an image gradient correction procedure is performed on the pre-processed image F2, a surface estimation procedure can be optionally performed on the pre-processed image F2.

In one embodiment, this surface estimation procedure can, for example but not limited to, estimate brightness information for at least a part of the pixels 37 of the pre-processed image F2, to generate brightness non-uniformity information of the pre-processed image F2.

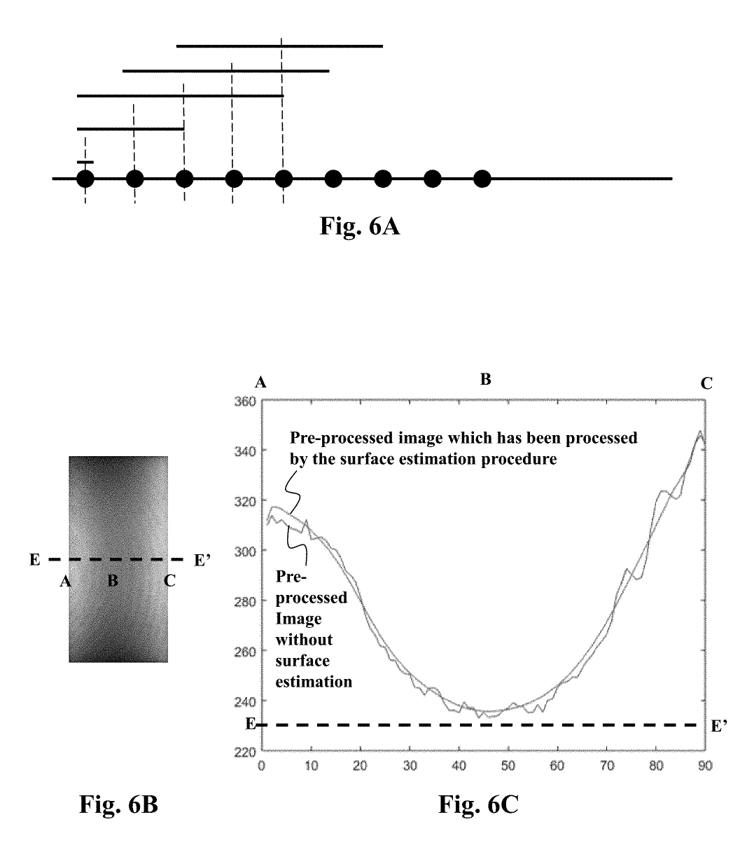

An example of the implementation and the result of this surface estimation procedure will be explained with reference to FIGS. 6A-6C.

Please refer to FIGS. 6A-6C. FIG. 6A shows a schematic diagram, explaining how the present invention performs a surface estimation procedure. FIG. 6B shows an example of the brightness of a pre-processed image whereon a surface estimation procedure has been performed. FIG. 6C shows a comparison between the pre-processed image which has been applied with a surface estimation procedure and the pre-processed image which has not been applied with a surface estimation procedure.

As shown in FIG. 6A, in one embodiment, this surface estimation procedure can be implemented via, for example but not limited to, a Variable Smooth Window Size Method. The relevant details of this “Variable Smooth Window Size Method” are now explained with reference to FIG. 6A.

As shown in FIG. 6A, the smooth window has a size and the size is variable. For example, the size of the smooth window can cover only one pixel, which for example can be applied to a pixel at an edge. For another example, the size of the smooth window can cover three pixels, which for example can be applied to a pixel which is next to an edge pixel. For still another example, the size of the smooth window can cover five pixels, which for example can be applied to a pixel not at an edge and not next to an edge pixel. The following description with respect to the “Variable Smooth Window Size Method” will take “five pixel as the smooth window” as an example.

More specifically, when the size of the smooth window covers five pixels, the brightness information of the pixel which is at the middle position (i.e., the 3^{rd} pixel) is equal to an average of the sum of respective brightness information of all five pixels; and similarly, when the size of the smooth window covers three pixels, the brightness information of the pixel which is at middle position (i.e., the 2^{nd} pixel) is equal to an average of the sum of respective brightness information of all three pixels

As shown in FIG. 6B, in a line EE, the pre-processed image F2 has different brightness at different positions (namely, position A, position B and position C). For example, the brightness of the pixels at position A and position C of the pre-processed image F2 are higher than the brightness of the pixel at position B of the pre-processed image F2. That is, the brightness of the pixels at position A and position C are relatively brighter, whereas, the brightness of the pixel at position B is relatively darker, as shown represented by the curve in FIG. 6C, wherein the curve of “pre-processed image without surface estimation” shows the brightness along the line EE in the pre-processed image F2 which has not yet been processed by the surface estimation procedure.

Please compare the curve of “pre-processed image without surface estimation” and the curve of “pre-processed image which has been processed by the surface estimation procedure” in FIG. 6C. As shown in FIG. 6C, the surface estimation procedure proposed by the present invention estimates brightness information of at least a part of the pixels 37 of the pre-processed image F2 (that is, the brightness of at least a part of the pixels 37 are replaced by the estimated value), so as to generate the brightness non-uniformity information of the pre-processed image F2 wherein minor fluctuations have been removed. The thus obtained brightness non-uniformity information of the pre-processed image F2 will be helpful to the subsequent image gradient correction procedure.

It is noteworthy that, the surface estimation procedure proposed by the present invention is not limited to the Variable Smooth Window Size Method; it is also practicable and within the scope of the present invention that the surface estimation procedure adopts any other method. For example, in another embodiment, the surface estimation procedure proposed by the present invention can be implemented via, for example but not limited to, a Replicate Method. In yet another embodiment, the surface estimation procedure proposed by the present invention can be implemented via, for example but not limited to, a Mirror Method. In still another embodiment, the surface estimation procedure proposed by the present invention can be implemented via, for example but not limited to, a Fixed Value Method.

The details of a Replicate Method, a Mirror Method or a Fixed Value Method are well known to those skilled in the art, so these methods are not redundantly explained here.

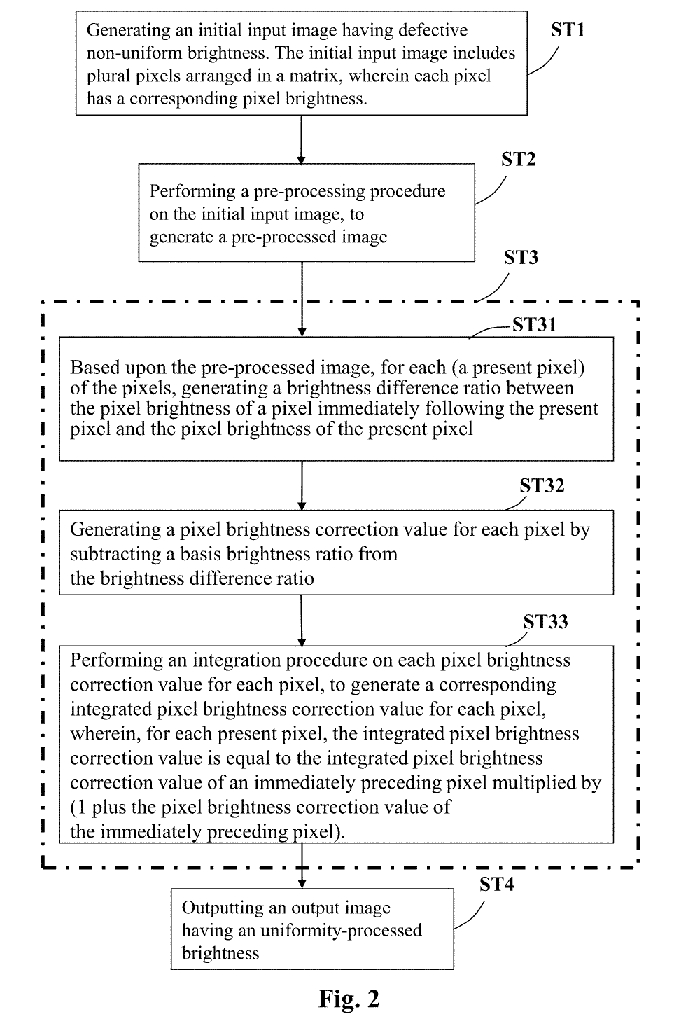

Please refer to FIGS. 1B-1C in conjugation with FIG. 2. FIG. 2 is a flowchart showing an image brightness non-uniformity correction method according to a specific embodiment of the present invention.

According to the present invention, the initial input image F1 having defective non-uniform brightness is first inputted into the pre-processing unit 22 (referring to step ST1 in FIG. 2). The pre-processing unit 22 performs a pre-processing procedure on the initial input image F1 having defective non-uniform brightness, to generate a pre-processed image F2 (referring to step ST2 in FIG. 2).

Next, the brightness non-uniformity information of the pre-processed image F2 is generated, and the above-mentioned surface estimation procedure can be optionally performed when generating the brightness non-uniformity information of the pre-processed image F2; in one embodiment, after the brightness non-uniformity information of the pre-processed image F2 has been generated, the pre-processed image F2 is inputted to the computation unit 23 wherein an image gradient correction procedure will be performed on the pre-processed image F2. Or, in another embodiment, the pre-processed image F2 can be directly inputted to the computation unit 23 (without being processed by the above-mentioned surface estimation procedure) wherein the image gradient correction procedure will be directly performed on the pre-processed image F2 (referring to step ST3 in FIG. 2).

The computation unit 23 is configured to operably perform an image gradient correction procedure on the pre-processed image F2 (referring to step ST3 in FIG. 2).

One advantage of the present invention is that the present invention eliminates the brightness non-uniformity of the initial input image F1 through the image gradient correction procedure.

After performing the image gradient correction procedure, the computation unit 23 outputs an output image F3 having an uniformity-processed brightness.

In one embodiment, the image gradient correction procedure performed by the computation unit 23 includes the following steps:

First, based upon the pre-processed image F2, for each (a present pixel) of the pixels 37, the image gradient correction procedure performed by the computation unit 23 generates a brightness difference ratio between the pixel brightness of an immediately following pixel and the pixel brightness of the present pixel (referring to step ST31 in FIG. 2).

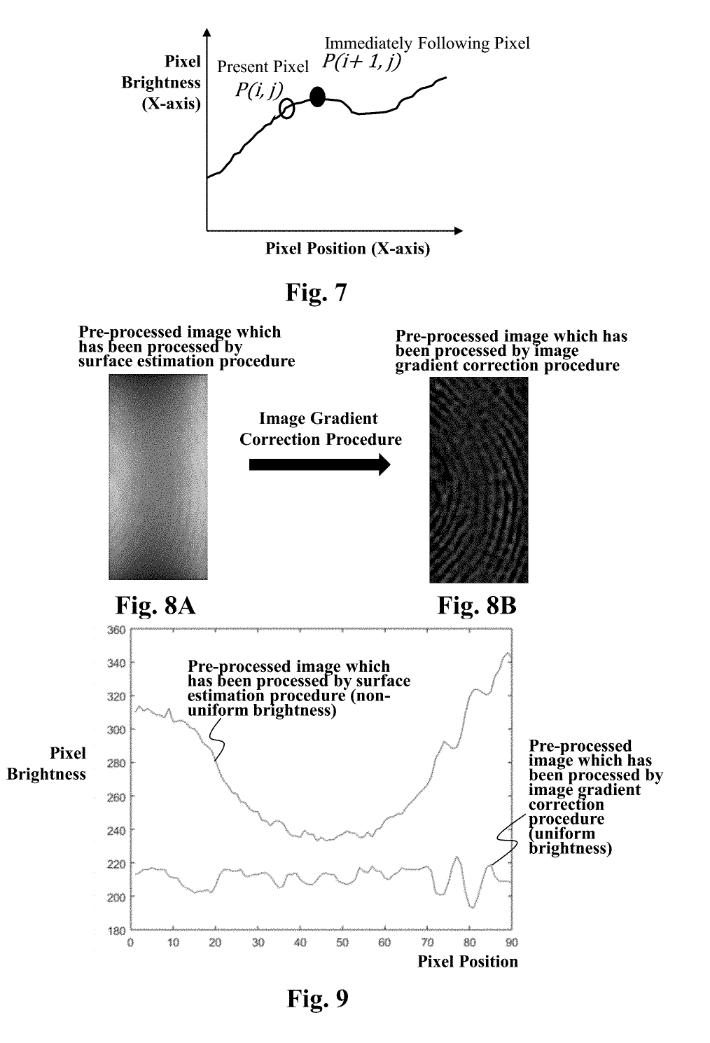

In one embodiment, step ST31 in FIG. 2 can be expressed as:

$${G}_{raw}^{x} ( i , j ) = \frac{P ( i + 1 , j ) - P ( i , j )}{P ( i , j )}$$

where P(i,j) denotes a pixel 37 (i.e., a present pixel, as shown in FIG. 7) at i^{th} row and j^{th} column of the pixel array 30 of the initial input image F1; P(i+1,j) denotes a pixel 37 (i.e., an immediately following pixel, as shown in FIG. 7) at i+1^{th} row and j^{th} column of the pixel array 30 of the initial input image F1; G_{raw}^{x}(i,j) denotes a brightness difference ratio of the present pixel in a horizontal direction (i.e., X-axis direction).

A brightness difference ratio in a horizontal direction (i.e., X-axis direction) between the present pixel P(i,j) and the immediately following pixel P(i+1,j) shown in FIG. 7 is obtained as described in the above. Likewise, a brightness difference ratio of a pixel 37 (i.e., the present pixel) in a vertical direction (i.e., Y-axis direction, wherein, X-axis direction and Y-axis direction are orthogonal to each other) can be obtained as:

$${G}_{raw}^{y} ( i , j ) = \frac{P ( i , j + 1 ) - P ( i , j )}{P ( i , j )}$$

where P(i,j) denotes a pixel 37 (i.e., a present pixel) at i^{th} row and j^{th} column of the pixel array 30 of the initial input image F1; P(i,j+1) denotes a pixel 37 (i.e., an immediately following pixel) at i^{th} row and j+1^{th} column of the pixel array 30 of the initial input image F1; G_{raw}^{y}(i,j) denotes a brightness difference ratio of the present pixel in a vertical direction (i.e., Y-axis direction).

Next, the image gradient correction procedure performed by the computation unit 23 generates a pixel brightness correction value for each pixel 37 by subtracting a basis brightness ratio from the brightness difference ratio (referring to step ST32 in FIG. 2).

In one embodiment, step ST32 in FIG. 2 can be expressed as:

G_{correct}^{x}(i,j)=G_{raw}^{x}(i,j)−G_{surface}^{x}(i,j)

where G_{raw}^{x}(i,j) denotes a brightness difference ratio of the present pixel P(i,j) in a horizontal direction (i.e., X-axis direction); G_{surface}^{x}(i,j) denotes a basis brightness ratio of each pixel 37 in the horizontal direction (i.e., X-axis direction); G_{correct}^{x}(i,j) denotes a pixel brightness correction value of the present pixel P(i,j) in the horizontal direction (i.e., X-axis direction).

Similar to the above, a pixel brightness correction value of a pixel 37 (i.e., the present pixel) in a vertical direction (i.e., Y-axis direction) can be obtained as:

G_{correct}^{y}(i,j)=G_{raw}^{y}(i,j)−G_{surface}^{y}(i,j)

where G_{raw}^{y}(i,j) denotes a brightness difference ratio of the present pixel P(i,j) in a vertical direction (i.e., Y-axis direction); G_{surface}^{y}(i,j) denotes a basis brightness ratio of each pixel 37 in the vertical direction (i.e., Y-axis direction); G_{correct}^{y}(i,j) denotes a pixel brightness correction value of the present pixel P(i,j) in the vertical direction (i.e., Y-axis direction).

Next, the image gradient correction procedure performed by the computation unit 23 performs an integration procedure on the pixel brightness correction value of each pixel 37, to generate a corresponding integrated pixel brightness correction value for each pixel 37. In one embodiment, the integrated pixel brightness correction value of each pixel 37 is equal to an integrated pixel brightness correction value of an immediately preceding pixel multiplied by (1 plus the pixel brightness correction value of the immediately preceding pixel) (referring to step ST33 in FIG. 2).

In one embodiment, step ST33 in FIG. 2 can be expressed as:

P_{correct}^{x}(i,j)=G_{correct}^{x}(i−1,j)*P_{correct}^{x}(i−1,j)+P_{correct}^{x}(i−1,j)

In an alternative expression, the above-mentioned equations can be defined as:

P_{correct}^{x}(i,j)=P_{correct}^{x}(i−1,j)*{1+G_{correct}^{x}(i−1,j)}

where P_{correct}^{x}(i−1,j) denotes an integrated pixel brightness correct correction value of an immediately preceding pixel (i.e., pixel P(i−1,j)) in a horizontal direction (i.e., X-axis direction); G_{correct}^{x}(i−1,j) denotes a pixel brightness correction correct value of the immediately preceding pixel (i.e., pixel P(i−1,j)) in the horizontal direction (i.e., X-axis direction); P_{correct}^{x}(i,j) denotes an integrated pixel brightness correction value of the present pixel P(i,j) in the horizontal direction (i.e., X-axis direction).

Similar to the above, an integrated pixel brightness correction value of the present pixel in a vertical direction (i.e., Y-axis direction) can be obtained as:

P_{correct}^{y}(i,j)=G_{correct}^{y}(i,j−1)*P_{correct}^{y}(i,j−1)+P_{correct}^{y}(i,j−1)

In an alternative expression, the above-mentioned equations can be defined as:

P_{correct}^{y}(i,j)=P_{correct}^{y}(i,j−1)*{1G_{correct}^{y}(i,j−1)}

where P_{correct}^{y}(i,j−1) denotes an integrated pixel brightness correction value of an immediately preceding pixel (i.e., pixel P(i,j−1)) in a vertical direction (i.e., Y-axis direction); G_{correct}^{y}(i,j−1) denotes a pixel brightness correction value of the immediately preceding pixel (i.e., pixel P(i,j−1)) in the vertical direction (i.e., Y-axis direction); P_{correct}^{y}(i,j) denotes an integrated pixel brightness correction value of the present pixel P(i,j) in the vertical direction (i.e., Y-axis direction).

Please refer to FIGS. 8A-8B and FIG. 9. FIG. 8A-8B show an example of the brightness of the pre-processed image, before and after an image gradient correction procedure has been performed on the pre-processed image. FIG. 9 shows a comparison between the pre-processed image which has been applied with the image gradient correction procedure and the pre-processed image which has not been applied with the image gradient correction procedure. As shown in FIG. 8A, although the pre-processed image F2 has been processed by the surface estimation procedure to remove minor fluctuations, the pre-processed image F2 still has defective non-uniform brightness. The pre-processed image F2 having defective non-uniform brightness in FIG. 8A corresponds to the curve “pre-processed image which has been processed by surface estimation procedure (non-uniform brightness)” in FIG. 9. FIG. 9 also shows that, even though the pre-processed image F2 has been processed by the surface estimation procedure to remove minor fluctuations, the pre-processed image F2 still has defective non-uniform brightness. For example, as shown in FIG. 8A and FIG. 9, the brightness of pixels near the center of the pre-processed image F2 are lower than the brightness of the pixels near the edge of the pre-processed image F2. The pixels near the center of the pre-processed image F2 suffer brightness degradation and are considerably darker than the pixels at the edge of the pre-processed image F2, which undesirably affects the accuracy in identifying the initial input image F1 (which is for example a fingerprint image).

However, as shown in FIG. 8B, one feature and advantage of the present invention is that the present invention can eliminate the brightness non-uniformity of the initial input image F1 through processing the pre-processed image F2 by the image gradient correction procedure. As shown in FIG. 8B, after the pre-processed image F2 is processed by the image gradient correction procedure, the defect of non-uniform brightness within the pre-processed image F2 is greatly reduced. The pre-processed image F2 in FIG. 8B, whose defect of non-uniform brightness is greatly reduced, corresponds to the curve of “pre-processed image which has been processed by image gradient correction procedure (uniform brightness)” in FIG. 9. It is apparent that after the pre-processed image F2 is processed by the image gradient correction procedure, the brightness of the pre-processed image F2 has become substantially uniform. For example, as shown in FIG. 8B and FIG. 9, after the pre-processed image F2 is processed by the image gradient correction procedure, it is clear that the brightness of pixels near the center of the pre-processed image F2 is substantially the same as the brightness of the pixels near the edge of the pre-processed image F2. As a result, the pixels near the center of the pre-processed image F2 no longer suffer brightness degradation and have substantially the same brightness as the pixels at the edge of the pre-processed image F2; this greatly improves the accuracy of identifying the initial input image F1 (which is for example a fingerprint image).

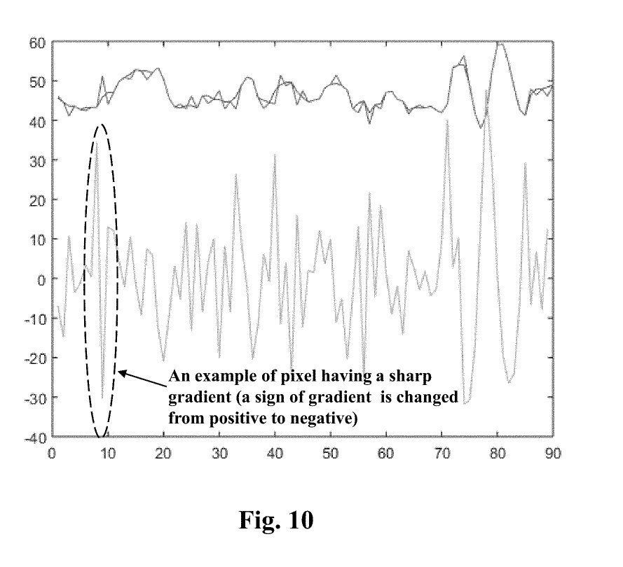

Please refer to FIG. 10 in conjugation with FIG. 2. FIG. 10 shows an example of a pixel having a sharp gradient after an image gradient correction procedure has been performed on the pre-processed image.

In one embodiment, after the step ST3 (i.e., the implementation of image gradient correction procedure) and before the step ST4 (i.e., the computation unit 23 outputs an output image F3 having an uniformity-processed brightness), the present invention can further eliminate a noise which is generated after the image gradient correction procedure has been performed.

For example, as shown in FIG. 10, the pre-processed image F2 has already been processed by the image gradient correction procedure, but this pre-processed image F2 has a noise. According to the present invention, for a pixel having a sharp gradient (with reference to neighboring pixels), the present invention will replace the integrated pixel brightness correction value of the pixel having the sharp gradient, by a predetermined brightness, to eliminate the noise.

In one embodiment, “a pixel having a sharp gradient” in a horizontal direction (i.e., X-axis direction) can be determined by:

sign(G_{correct}^{x}(i−1,j)≠sign(G_{correct}^{x}(i,j))

where sign(G_{correct}^{x}(i−1,j)) denotes a positive sign or a negative sign of a pixel brightness correction value of the immediately preceding pixel (i.e., pixel P(i−1,j)) in the horizontal direction (i.e., X-axis direction); sign(G_{correct}^{x}(i,j)) denotes a positive sign or a negative sign of a pixel brightness correction value of the present pixel P(i,j) in the horizontal direction (i.e., X-axis direction).

That is, when the sign of the pixel brightness correction value of the immediately preceding pixel (i.e., pixel P(i−1,j)) in the X-axis direction is not equal to the sign of the pixel brightness correction value of the present pixel P(i,j) in the X-axis direction, this indicates that a noise defect of “sharp gradient” in the X-axis direction occurs in the pixel at this position (as shown by the dashed circle in FIG. 10).

Similarly, whether each pixel 37 has a noise defect of “sharp gradient” in a vertical direction (i.e., Y-axis direction) can be determined by:

sign(G_{correct}^{y}(i,j−1))≠sign(G_{correct}^{y}(i,j))

where sign(G_{correct}^{y}(i,j−1)) denotes a positive sign or a negative sign of a pixel brightness correction value of the immediately preceding pixel (i.e., pixel P(i,j−1)) in the vertical direction (i.e., Y-axis direction); sign(G_{correct}^{y}(i,j)) denotes a positive sign or a negative sign of a pixel brightness correction value of the present pixel P(i,j) in the vertical direction (i.e., Y-axis direction).

That is, when the sign of the pixel brightness correction value of the immediately preceding pixel (i.e., P(i,j−1)) in the Y-axis direction is not equal to the sign of the pixel brightness correction value of the present pixel P(i,j) in the Y-axis direction, this indicates that a noise defect of “sharp gradient” in the Y-axis direction occurs in the pixel at this position (as shown by the dashed circle in FIG. 10).

When it is determined that a pixel has a noise defect of “sharp gradient” in a horizontal direction or a vertical direction, the present invention can remedy such undesirable noise defect by replacing the integrated pixel brightness correction value of the pixel having the sharp gradient by a predetermined brightness, to eliminate a noise in the pre-processed image F2 after it is processed by the image gradient correction procedure.

In one embodiment, “replacing the integrated pixel brightness correction value of the pixel having the sharp gradient by a predetermined brightness” can be expressed as:

P_{correct}(i,j)=P_{correct}^{median}(i,j)

where P_{correct}(i,j) denotes an integrated pixel brightness correction value of the pixel having the sharp gradient; P_{correct}^{median}(i,j) denotes a middle value of the integrated pixel brightness correction value of the pixel having the sharp gradient. The middle value is for example obtained from at least a part of the pixels, such as an average of the brightness of a predetermined number of neighboring pixels, or a preset value.

As such, after the pre-processed image F2 is processed by the image gradient correction procedure, the present invention can further eliminate a noise defect of “sharp gradient” within the pre-processed image F2. Thus, before the step ST4 (i.e., the computation unit 23 outputs an output image F3 having an uniformity-processed brightness), a pre-processed image F2 having a more accurate uniform brightness can be obtained.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover both such and other modifications and variations, which should be interpreted to fall within the scope of the following claims and their equivalents.

What is claimed is:

1. An image brightness non-uniformity correction method, comprising the steps of:
(A) generating an initial input image, wherein the initial input image includes a plurality of pixels arranged in a matrix, wherein each pixel has a corresponding pixel brightness and the initial input image has defective non-uniform brightness;
(B) performing a pre-processing procedure on the initial input image, to generate a pre-processed image;
(C) performing an image gradient correction procedure on the pre-processed image, wherein, the image gradient correction procedure is adopted for eliminating non-uniformity of the brightness of the initial input image; and
(D) outputting an output image having an uniformity-processed brightness;
wherein, the image gradient correction procedure includes the steps of:
(C1) based upon the pre-processed image, for each (a present pixel) of the pixels, generating a brightness difference ratio between the pixel brightness of a pixel immediately following the present pixel and the pixel brightness of the present pixel;
(C2) generating a pixel brightness correction value for each pixel by subtracting a basis brightness ratio from the brightness difference ratio; and
(C3) performing an integration procedure on each pixel brightness correction value for each pixel, to generate a corresponding integrated pixel brightness correction value for each pixel, wherein, for each present pixel, the integrated pixel brightness correction value is equal to the integrated pixel brightness correction value of an immediately preceding pixel multiplied by (1 plus the pixel brightness correction value of the immediately preceding pixel).

2. The image brightness non-uniformity correction method of claim 1, further comprising:
before the step (C), estimating brightness information for at least a part of the pixels of the pre-processed image, to generate information of the brightness non-uniformity of the pre-processed image.

3. The image brightness non-uniformity correction method of claim 1, further comprising:
after the step (C) and before the step (D), for a pixel having a sharp gradient, replacing the integrated pixel brightness correction value of the pixel having the sharp gradient with a predetermined brightness, to eliminate a noise which is generated after the image gradient correction procedure has been performed.

4. The image brightness non-uniformity correction method of claim 3, wherein the predetermined brightness is a middle value obtained from the integrated pixel brightness correction values of at least a part of the pixels.

5. The image brightness non-uniformity correction method of claim 1, wherein the pre-processing procedure includes the steps of:
(B1) performing a defect removing procedure on the initial input image, to remove a pixel having defective image information;
(B2) performing a smoothing procedure on the defect-removed initial input image, to reduce noise interference on the initial input image; and
(B3) performing a sharping procedure on the smoothed initial input image, to enhance contrast among the pixel brightness of the pixels near the edge of the initial input image.

6. An image brightness correction device, comprising:
an image input unit, which is configured to operably generate an initial input image, wherein the initial input image includes a plurality of pixels arranged in a matrix, wherein each pixel has a corresponding pixel brightness and the initial input image has defective non-uniform brightness;
a pre-processing unit, which is configured to operably perform a pre-processing procedure on the initial input image, to generate a pre-processed image; and
a computation unit, which is configured to operably perform an image gradient correction procedure on the pre-processed image, wherein, the image gradient correction procedure is adopted for eliminating non-uniformity of the brightness of the initial input image; and wherein, after performing the image gradient correction procedure, the computation unit outputs an output image having an uniformity-processed brightness.

7. The image brightness correction device of claim 6, wherein the image gradient correction procedure performed by the computation unit includes the steps of:
based upon the pre-processed image, for each (a present pixel) of the pixels, generating a brightness difference ratio between the pixel brightness of a pixel immediately following the present pixel and the pixel brightness of the present pixel;
generating a pixel brightness correction value for each pixel by subtracting a basis brightness ratio from the brightness difference ratio; and
performing an integration procedure on each pixel brightness correction value for each pixel, to generate a corresponding integrated pixel brightness correction value for each pixel, wherein, for each present pixel, the integrated pixel brightness correction value is equal to the integrated pixel brightness correction value of an immediately preceding pixel multiplied by (1 plus the pixel brightness correction value of the immediately preceding pixel).
